(19) United States
(12) Patent Application Publication
(10) Pub. No.: US 2024/0274850 A1
(43) Pub. Date: Aug. 15, 2024

(54) ELECTROLYTE SHEET FOR SOLID OXIDE FUEL BATTERY, AND UNIT CELL FOR SOLID OXIDE FUEL BATTERY

(71) Applicant: Murata Manufacturing Co., Ltd., Nagaokakyo-shi (JP)

(72) Inventors: Seiji FUJITA, Nagaokakyo-shi (JP); Hiroaki YAMADA, Nagaokakyo-shi (JP)

(21) Appl. No.: 18/644,571

(22) Filed: Apr. 24, 2024

Related U.S. Application Data
(63) Continuation of application No. PCT/JP2022/044868, filed on Dec. 6, 2022.

(30) Foreign Application Priority Data
Dec. 27, 2021 (JP) 2021-212706

(51) Int. Cl. H01M 8/1253; H01M 8/12; H01M 8/2432

(52) U.S. Cl. CPC H01M 8/1253; H01M 8/2432; H01M 2008/1293

(57) ABSTRACT

An electrolyte sheet for solid oxide fuel cells, wherein at least one main surface of the electrolyte sheet includes first recesses and second recesses, the second recesses each having a smaller diameter than the first recesses, the first recesses are spaced apart at an interval from each other, the second recesses are present between openings of adjacent first recesses among the first recesses, on side faces of the first recesses, and on bottom faces of the first recesses, at least one of the first recesses has an opening with a diameter of 60 μm or more, and the at least one of the first recesses has a ratio of the diameter of the opening to a diameter of the bottom face of 30% or more.

### CROSS REFERENCE TO RELATED APPLICATIONS

The present application is a continuation of International application No. PCT/JP2022/044868, filed Dec. 6, 2022, which claims priority to Japanese Patent Application No. 2021-212706, filed Dec. 27, 2021, the entire contents of each of which are incorporated herein by reference.

### TECHNICAL FIELD

The present description relates to an electrolyte sheet for solid oxide fuel cells and a unit cell for solid oxide fuel cells.

### BACKGROUND ART

A solid oxide fuel cell (SOFC) is a device that produces electric energy through reactions of H₂+O²⁻→H₂O+2e⁻ at a fuel electrode and (½) O₂+2e⁻ →O²⁻ at an air electrode. A solid oxide fuel cell is a stack of unit cells for solid oxide fuel cells. Each unit cell includes an electrolyte sheet for solid oxide fuel cells, which includes a ceramic plate body, and a fuel electrode and an air electrode disposed on the electrolyte sheet.

Patent Literature 1 discloses a solid oxide fuel cell including an electrolyte layer, an air electrode on a surface of the electrolyte layer, and a fuel electrode on the other surface of the electrolyte layer. In the solid oxide fuel cell, a porous layer of an electrolyte material is interposed between the electrolyte layer and the air electrode and/or between the electrolyte layer and the fuel electrode.
Patent Literature 1: JP 2006-339034 A

### SUMMARY OF THE DESCRIPTION

In the solid oxide fuel cell in Patent Literature 1, the porous layer of an electrolyte material is interposed between the electrolyte layer and the air electrode and/or between the electrolyte layer and the fuel electrode to increase the contact area between the electrolyte layer and the electrode (at least one of the air electrode and the fuel electrode). However, in the solid oxide fuel cell in Patent Literature 1, a slurry for the electrode does not easily enter the openings with small diameters of the porous layer as shown in FIG. 3 and FIG. 4 of Patent Literature 1. Since the electrolyte layer does not have a sufficiently large contact area with the electrode (s), the power generation efficiency may be difficult to improve.

The present description was made to solve the above problem and aims to provide an electrolyte sheet for solid oxide fuel cells capable of improving the power generation efficiency of the solid oxide fuel cells. The present description also aims to provide a unit cell for solid oxide fuel cells, the unit cell including the above-described electrolyte sheet.

An electrolyte sheet for solid oxide fuel cells of the present description has the following features: at least one main surface of the electrolyte sheet includes first recesses and second recesses, the second recesses each having a smaller diameter than the first recesses, the first recesses are spaced apart at an interval from each other, the second recesses are present between openings of adjacent first recesses among the first recesses, on side faces of the first recesses, and on bottom faces of the first recesses, at least one of the first recesses has an opening with a diameter of 60 μm or more, and the at least one of the first recesses has a ratio of the diameter of the opening to a diameter of the bottom face of 30% or more.

A unit cell for solid oxide fuel cells of the present description includes: a fuel electrode; an air electrode; and the electrolyte sheet for solid oxide fuel cells of the present description between the fuel electrode and the air electrode.

The present description can provide an electrolyte sheet for solid oxide fuel cells capable of improving the power generation efficiency of the solid oxide fuel cells. The present description can also provide a unit cell for solid oxide fuel cells, the unit cell including the above-described electrolyte sheet.

### BRIEF DESCRIPTION OF THE DRAWINGS

FIG. 1 is a schematic plan view of an example of the electrolyte sheet for solid oxide fuel cells of the present description.

FIG. 2 is a schematic cross-sectional view of an example of a cross-section along line A1-A2 of the electrolyte sheet in FIG. 1.

FIG. 3 is an enlarged schematic cross-sectional view of a first main surface of the electrolyte sheet in FIG. 2.

FIG. 4 is a schematic cross-sectional view of another example of the electrolyte sheet for solid oxide fuel cells of the present description in which the cross-sectional shape of each first recess is different from that in FIG. 3.

FIG. 5 is a schematic cross-sectional view of still another example of the electrolyte sheet for solid oxide fuel cells of the present description in which the cross-sectional shape of each first recess is different from that in FIG. 3 and that in FIG. 4.

FIG. 6 is a schematic plan view showing production of ceramic green sheets in an example of a method of producing the electrolyte sheet for solid oxide fuel cells of the present description.

FIG. 7 is a schematic plan view showing an embodiment after the state in FIG. 6 in the production of ceramic green sheets in the example of the method of producing the electrolyte sheet for solid oxide fuel cells of the present description.

FIG. 8 is a schematic plan view showing an embodiment after the state in FIG. 7 in the production of ceramic green sheets in the example of the method of producing the electrolyte sheet for solid oxide fuel cells of the present description.

FIG. 9 is a schematic cross-sectional view showing formation of sheet through holes in the example of the method of producing the electrolyte sheet for solid oxide fuel cells of the present description.

FIG. 10 is a schematic cross-sectional view showing production of an unsintered plate body in the example of the method of producing the electrolyte sheet for solid oxide fuel cells of the present description.

FIG. 11 is a schematic cross-sectional view showing formation of second recesses in the example of the method of producing the electrolyte sheet for solid oxide fuel cells of the present description.

FIG. 12 is a schematic cross-sectional view showing an embodiment after the state in FIG. 11 in the formation of second recesses in the example of the method of producing the electrolyte sheet for solid oxide fuel cells of the present description.

FIG. 13 is a schematic cross-sectional view showing an embodiment after the state in FIG. 12 in the formation of second recesses in the example of the method of producing the electrolyte sheet for solid oxide fuel cells of the present description.

FIG. 14 is a schematic cross-sectional view showing an embodiment after the state in FIG. 13 in the formation of second recesses in the example of the method of producing the electrolyte sheet for solid oxide fuel cells of the present description.

FIG. 15 is a schematic cross-sectional view showing production of a ceramic plate body in the example of the method of producing the electrolyte sheet for solid oxide fuel cells of the present description.

FIG. 16 is a schematic cross-sectional view of an example of the unit cell for solid oxide fuel cells of the present description.

FIG. 17 is an enlarged schematic cross-sectional view of an interface between an electrolyte sheet and a fuel electrode in the unit cell in FIG. 16.

FIG. 18 is an enlarged schematic cross-sectional view of an interface between an electrolyte sheet and an air electrode in the unit cell in FIG. 16.

FIG. 19 is a schematic perspective view of a unit cell sample for measuring power generation efficiency.

### DESCRIPTION OF THE PREFERRED EMBODIMENTS

The electrolyte sheet for solid oxide fuel cells of the present description and the unit cell for solid oxide fuel cells of the present description are described below. The present description is not limited to the following preferred embodiments and may be appropriately modified without departing from the gist of the present description. Combinations of two or more preferred features described in the following preferred embodiments are also within the scope of the present description.

The drawings are schematic drawings, and the dimensions, the aspect ratio, the scale, and other parameters may differ from those of the actual products.

### Electrolyte Sheet for Solid Oxide Fuel Cells

In the electrolyte sheet for solid oxide fuel cells of the present description, at least one main surface of the electrolyte sheet includes first recesses and second recesses, the second recesses each having a smaller diameter than the first recesses, the first recesses are spaced apart at an interval from each other, and the second recesses are present between openings of adjacent first recesses among the first recesses, on side faces of the first recesses, and on bottom faces of the first recesses.

An example of the electrolyte sheet for solid oxide fuel cells of the present description is described below.

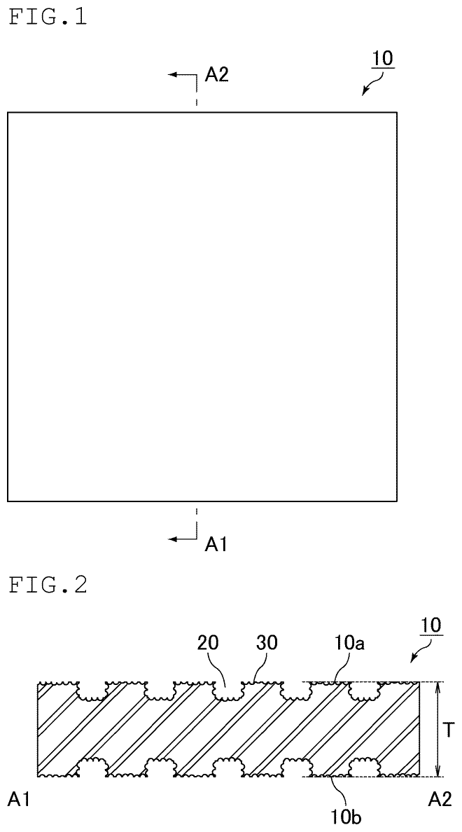

FIG. 1 is a schematic plan view of an example of the electrolyte sheet for solid oxide fuel cells of the present description.

An electrolyte sheet 10 for solid oxide fuel cells shown in FIG. 1 includes a ceramic plate body.

The ceramic plate body preferably contains sintered zirconia.

Examples of the sintered zirconia include those stabilized with an oxide of a rare-earth element such as scandium or yttrium. Specific examples include sintered scandia-stabilized zirconia and sintered yttria-stabilized zirconia.

Preferably, the sintered zirconia is sintered scandia-stabilized zirconia. Specifically, the ceramic plate body in the electrolyte sheet 10 preferably contains sintered scandia-stabilized zirconia. The electrolyte sheet 10 that includes a ceramic plate body containing sintered scandia-stabilized zirconia is likely to have a higher conductivity. In this case, the electrolyte sheet 10, when incorporated into a solid oxide fuel cell, is likely to improve the power generation efficiency of the solid oxide fuel cell.

Preferably, the sintered zirconia is sintered cubic zirconia. Specifically, the ceramic plate body in the electrolyte sheet 10 preferably contains sintered cubic zirconia. The electrolyte sheet 10 that includes a ceramic plate body containing sintered cubic zirconia is likely to have a higher conductivity. In this case, the electrolyte sheet 10, when incorporated into a solid oxide fuel cell, is likely to improve the power generation efficiency of the solid oxide fuel cell.

Examples of the sintered cubic zirconia include those stabilized with an oxide of a rare-earth element such as scandium or yttrium. Specific examples include sintered scandia-stabilized cubic zirconia and sintered yttria-stabilized cubic zirconia.

Preferably, the sintered cubic zirconia is sintered scandia-stabilized cubic zirconia. Specifically, the ceramic plate body in the electrolyte sheet 10 preferably contains sintered scandia-stabilized cubic zirconia. The electrolyte sheet 10 that includes a ceramic plate body containing sintered scandia-stabilized cubic zirconia is likely to have a significantly higher conductivity. In this case, the electrolyte sheet 10, when incorporated into a solid oxide fuel cell, is likely to significantly improve the power generation efficiency of the solid oxide fuel cell.

The planer shape of the electrolyte sheet 10 in a view in the thickness direction is square as shown in FIG. 1, for example.

Though not shown, the planer shape of the electrolyte sheet 10 in a view in the thickness direction is preferably substantially a rectangle with rounded corners, more preferably substantially square with rounded corners. In this case, all the corners of the electrolyte sheet 10 may be rounded, or one or some corners thereof may be rounded.

Though not shown, the electrolyte sheet 10 is preferably provided with a through hole penetrating the electrolyte sheet 10 in the thickness direction. Such a through hole functions as a gas flow path when the electrolyte sheet 10 is incorporated into a solid oxide fuel cell.

Only one through hole may be provided, or two or more through holes may be provided.

The planer shape of the through hole in a view in the thickness direction may be circular or any other shape.

The through hole may be provided at any position in a region where none of first recesses 20 described later and second recesses 30 described later present between the openings of the first recesses 20 is lost by the through hole.

In a view in the thickness direction, the electrolyte sheet 10 has a size of, for example, 50 mm×50 mm, 100 mm×100 mm, 110 mm×110 mm, 120 mm×120 mm, or 200 mm×200 mm.

FIG. 2 is a schematic cross-sectional view of an example of a cross-section along line A1-A2 of the electrolyte sheet in FIG. 1.

As shown in FIG. 2, at least one main surface of the electrolyte sheet 10 includes first recesses 20 and second recesses 30 each having a smaller diameter than the first recesses 20.

In the example as a preferred embodiment shown in FIG. 2, the first recesses 20 and the second recesses 30 are present on both a first main surface 10a and a second main surface 10b of the electrolyte sheet 10.

In the case where the first recesses 20 and the second recesses 30 are present on both the first main surface 10a and the second main surface 10b of the electrolyte sheet 10, the first recesses 20 on the first main surface 10a and the first recesses 20 on the second main surface 10b may overlap in the thickness direction as shown in FIG. 2 or may not overlap in the thickness direction.

The first recesses 20 and the second recesses 30 may be present only on the first main surface 10a of the electrolyte sheet 10 or only on the second main surface 10b of the electrolyte sheet 10.

The first recesses 20 and the second recesses 30 on the first main surface 10a of the electrolyte sheet 10 are described below. The description also applies to the first recesses 20 and the second recesses 30 on the second main surface 10b of the electrolyte sheet 10.

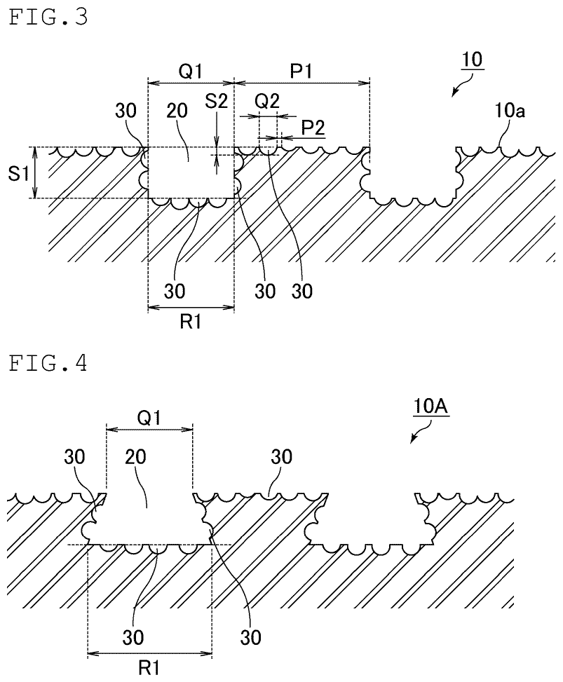

FIG. 3 is an enlarged schematic cross-sectional view of a first main surface of the electrolyte sheet in FIG. 2.

As shown in FIG. 3, the first recesses 20 are spaced apart at an interval from each other on the first main surface 10a of the electrolyte sheet 10. The first recesses 20 on the first main surface 10a of the electrolyte sheet 10 increase the surface area of the first main surface 10a of the electrolyte sheet 10. Thus, when the electrolyte sheet 10 is incorporated into a solid oxide fuel cell, the electrolyte sheet 10 tends to have a large contact area with the electrode (fuel electrode or air electrode), thereby facilitating the improvement of the power generation efficiency.

As shown in FIG. 3, the second recesses 30 are present on the first main surface 10a of the electrolyte sheet 10 between the openings of the adjacent first recesses 20, on the side faces of the first recesses 20, and on the bottom faces of the first recesses 20. The second recesses 30 on the first main surface 10a of the electrolyte sheet 10 increase the surface area of the first main surface 10a of the electrolyte sheet 10. Thus, when the electrolyte sheet 10 is incorporated into a solid oxide fuel cell, the electrolyte sheet 10 tends to have a large contact area with the electrode (fuel electrode or air electrode), thereby facilitating the improvement of the power generation efficiency.

Preferably, a plurality of the second recesses 30 are present between the openings of the adjacent first recesses 20 as shown in FIG. 3.

Preferably, a plurality of the second recesses 30 are present on each side face of the first recesses 20 as shown in FIG. 3.

Preferably, a plurality of the second recesses 30 are present on each bottom face of the first recesses 20 as shown in FIG. 3.

As described above, the first recesses 20 and the second recesses 30 on the first main surface 10a of the electrolyte sheet 10 significantly increase the surface area of the first main surface 10a of the electrolyte sheet 10. Thus, when the electrolyte sheet 10 is incorporated into a solid oxide fuel cell, the electrolyte sheet 10 tends to have a significantly large contact area with the electrode (fuel electrode or air electrode), thereby significantly facilitating the improvement of the power generation efficiency.

An interval (pitch) P1 between the adjacent first recesses 20 is preferably 50 μm to 200 μm, more preferably 50 μm to 150 μm, still more preferably 50 μm to 100 μm.

All the intervals P1 between the adjacent first recesses 20 among the first recesses 20 may be the same or different from each other, or some of them may be different from each other.

The interval between the adjacent first recesses is defined by the shortest distance between the openings of the adjacent first recesses in a view in the thickness direction.

In the electrolyte sheet for solid oxide fuel cells of the present description, at least one of the first recesses has an opening with a diameter of 60 μm or more.

At least one of the first recesses 20 has an opening with a diameter Q1 of 60 μm or more. When the electrolyte sheet 10 with the at least one of the first recesses 20 having an opening with a diameter Q1 of 60 μm or more is incorporated into a solid oxide fuel cell, the slurry for an electrode (slurry for a fuel electrode or slurry for an air electrode) easily enters the first recesses 20 and also easily enters the second recesses 30 on the side faces and the bottom faces of the first recesses 20. In the resulting solid oxide fuel cell, the electrolyte sheet 10 tends to have a large contact area with the electrode, thereby facilitating the improvement of the power generation efficiency.

The diameter Q1 of the opening of at least one of the first recesses 20 is preferably 200 μm or less.

The diameter Q1 of the opening of at least one of the first recesses 20 is preferably 60 μm to 200 μm.

All the diameters Q1 of the openings of the first recesses 20 may be the same or different from each other, or some of them may be different from each other.

The diameter of the opening of each first recess is determined as follows. First, an image of the opening of a first recess in a view in the thickness direction is captured. Next, the captured image of the opening of the first recess is subjected to image analysis using image analysis software to measure the equivalent circular diameter of the opening of the first recess. The equivalent circular diameter measured as described above is determined as the diameter of the opening of the first recess.

In the electrolyte sheet for solid oxide fuel cells of the present description, the at least one of the first recesses has a ratio of the diameter of the opening to the diameter of the bottom face of 30% or more.

The at least one of the first recesses 20 has a ratio of the diameter Q1 of the opening to a diameter R1 of the bottom face (100×Q1/R1) of 30% or more. When the electrolyte sheet 10 with the at least one of the first recesses 20 having a ratio of the diameter Q1 of the opening to the diameter R1 of the bottom face of 30% or more is incorporated into a solid oxide fuel cell, the slurry for an electrode (slurry for a fuel electrode or slurry for an air electrode) easily enters the first recesses 20 and also easily enters the second recesses 30 on the side faces and the bottom faces of the first recesses 20. In the resulting solid oxide fuel cell, the electrolyte sheet 10 tends to have a large contact area with the electrode, thereby facilitating the improvement of the power generation efficiency.

The at least one of the first recesses 20 has a ratio of the diameter Q1 of the opening to the diameter R1 of the bottom face of preferably 150% or less, more preferably 130% or less.

The at least one of the first recesses 20 has a ratio of the diameter Q1 of the opening to the diameter R1 of the bottom face of preferably 30% to 150%, more preferably 30% to 130%.

All the diameters R1 of the bottom faces of the first recesses 20 may be the same or different from each other, or some of them may be different from each other.

The diameter of the bottom face of each first recess is determined as follows. First, an image of a first recess is captured by applying ultrasonic waves to the first recess using an ultrasonic microscope (C-SAM). Here, the image of the first recess can be captured with high accuracy by, for example, using an ultrasonic microscope including a transducer of 200 MHz or more. Next, the captured image of the first recess is subjected to image analysis using image analysis software to measure the equivalent circular diameter, perpendicular to the thickness direction, of the first recess at a position 1 μm away from the deepest point of the bottom face with the second recesses toward the opening side in the thickness direction. The equivalent circular diameter measured as described above is determined as the diameter of the bottom face of the first recess.

When the electrolyte sheet 10 with at least one of the first recesses 20 having an opening with a diameter Q1 of 60 μm or more and having a ratio of the diameter Q1 of the opening to the diameter R1 of the bottom face of 30% or more is incorporated into a solid oxide fuel cell, the slurry for an electrode (slurry for a fuel electrode or slurry for an air electrode) significantly easily enters the first recesses 20 and also easily enters the second recesses 30 on the side faces and the bottom faces of the first recesses 20. In the resulting solid oxide fuel cell, the electrolyte sheet 10 tends to have a significantly large contact area with an electrode, thereby significantly facilitating the improvement of the power generation efficiency.

As described above, at least one main surface (both main surfaces in the example in FIG. 2) of the electrolyte sheet 10 includes the first recesses 20 and the second recesses 30. Also, in the electrolyte sheet 10, at least one of the first recesses 20 has an opening with a diameter Q1 of 60 μm or more, and has a ratio of the diameter Q1 of the opening to the diameter R1 of the bottom face of 30% or more. Thus, the electrolyte sheet 10 can improve the power generation efficiency of solid oxide fuel cells.

In the electrolyte sheet 10, it is sufficient that at least one of the first recesses 20 has an opening with a diameter Q1 of 60 μm or more and has a ratio of the diameter Q1 of the opening to the diameter R1 of the bottom face of 30% or more. Particularly preferably, all the first recesses 20 satisfy the feature.

In the electrolyte sheet for solid oxide fuel cells of the present description, a ratio of a depth of the at least one of the first recesses to a thickness of the electrolyte sheet is preferably 20% or less.

The ratio of a depth S1 of the at least one of the first recesses 20 to a thickness T of the electrolyte sheet 10 (100×S1/T) is preferably 20% or less. When the electrolyte sheet 10 includes at least one of the first recesses 20 having an excessively large depth S1, the substantial thickness of the electrolyte sheet 10 is too small, possibly reducing the strength of the electrolyte sheet 10. In contrast, when the ratio of the depth S1 of at least one of the first recesses 20 to the thickness T of the electrolyte sheet 10 is 20% or less, the electrolyte sheet 10 reliably has a sufficient substantial thickness. Thus, the electrolyte sheet 10 tends not to reduce the strength.

The ratio of the depth S1 of the at least one of the first recesses 20 to the thickness T of the electrolyte sheet 10 is preferably 10% or more.

The ratio of the depth S1 of the at least one of the first recess 20 to the thickness T of the electrolyte sheet 10 is preferably 10% to 20%.

All the first recesses 20 may have the same depth S1 or different depths S1, or some of them may have different depths S1.

The depth of each first recess is determined by a distance in the thickness direction between the opening of the first recess and a position 1 μm away from the deepest point of the bottom face with the second recesses toward the opening side of the first recess in the thickness direction. The position 1 μm away from the deepest point of the bottom face with the second recesses toward the opening side of the first recess in the thickness direction is determined as in the determination of the diameter of the bottom face of each first recess.

In the electrolyte sheet 10, it is preferable that the ratio of the depth S1 of at least one of the first recesses 20 to the thickness T of the electrolyte sheet 10 is 20% or less. Particularly preferably, all the first recesses 20 satisfy the feature.

The number of the first recesses 20 may be any integer larger than 1.

The first recesses 20 may be regularly or irregularly present.

Examples of the three-dimensional shape of the first recesses 20 include columnar shapes such as a rectangular pillar shape and a cylindrical shape. Preferably, the three-dimensional shape of the first recesses 20 is a quadrangular pillar shape.

The first recesses 20 preferably have the same three-dimensional shape. All the first recesses 20 may have the same three-dimensional shape or different three-dimensional shapes, or some of them may have different three-dimensional shapes.

The interval (pitch) P2 between the adjacent second recesses 30 is preferably 1 μm to 5 μm.

The adjacent second recesses 30 may not have the interval P2. Specifically, the adjacent second recesses 30 may be in contact with each other with no interval.

All the intervals P2 between the adjacent second recesses 30 among the second recesses 30 may be the same or different from each other, or some of them may be different from each other.

The interval between adjacent second recesses is determined by the shortest distance between the openings of the adjacent second recesses in a view in the thickness direction.

The diameters of the second recesses 30 are smaller than the diameters of the first recesses 20. Specifically, diameters Q2 of the openings of the second recesses 30 are smaller than the diameters Q1 of the openings of the first recesses 20.

The diameter Q2 of the opening of at least one of the second recesses 30 is preferably 1 μm to 5 μm.

The ratio of the diameter Q2 of the opening of at least one of the second recesses 30 to the diameter Q1 of the opening of at least one of the first recesses 20 (100×Q2/Q1) is preferably 0.5% to 8.5%.

All the diameters Q2 of the openings of the second recesses 30 may be the same or different from each other, or some of them may be different from each other.

The diameter of the opening of each second recess is determined as described for the diameter of the opening of each first recess.

All depths S2 of the second recesses 30 may be the same or different from each other, or some of them may be different from each other.

The depth of each second recess is determined as follows. First, an image of a second recess is captured by applying ultrasonic waves to the second recess using an ultrasonic microscope. Here, the image of the second recess can be captured with high accuracy by, for example, using an ultrasonic microscope including a transducer of 200 MHz or more. Next, the captured image of the second recess is subjected to image analysis using image analysis software to measure the distance in the thickness direction between the deepest point and the opening of the second recess. The measured distance is defined as the depth of the second recess.

The number of the second recesses 30 may be any integer larger than 1.

The second recesses 30 may be regularly or irregularly present.

Examples of the three-dimensional shape of the second recesses 30 include partial sphere shapes.

Specifically, the bottom face of each second recess 30 may be curved. The bottom face of each second recess 30 may be flat, not curved.

The second recesses 30 preferably have the same three-dimensional shape. All the second recesses 30 may have the same three-dimensional shape or different three-dimensional shapes, or some of them may have different three-dimensional shapes.

The thickness T of the electrolyte sheet 10 is preferably 200 μm or less, more preferably 130 μm or less.

The thickness T of the electrolyte sheet 10 is preferably 30 μm or more, more preferably 50 μm or more.

The thickness T of the electrolyte sheet 10 is preferably 30 μm to 200 μm, more preferably 50 μm to 130 μm.

The thickness of the electrolyte sheet is determined as follows. First, the thicknesses at arbitrary nine sites of the electrolyte sheet in a region with no first recess are measured using, for example, a U-shape steel sheet micrometer “PMU-MX” available from Mitutoyo. Next, the thicknesses at the nine sites are averaged, and the average is determined as the thickness of the electrolyte sheet.

FIG. 3 shows an example with a shape in which the diameter Q1 of the opening of each first recess 20 is almost equal to the diameter R1 of the bottom face of the first recess 20 in a cross-section of the first recess 20 in a view along the thickness direction. The cross-sectional shape of at least one of the first recesses 20 may be different from the cross-sectional shape in FIG. 3 as long as the at least one of the first recesses 20 has an opening with the diameter Q1 of 60 μm or more and also has the ratio of the diameter Q1 of the opening to the diameter R1 of the bottom face of 30% or more.

FIG. 4 is a schematic cross-sectional view of another example of the electrolyte sheet for solid oxide fuel cells of the present description in which the cross-sectional shape of each first recess is different from that in FIG. 3.

As seen in an electrolyte sheet 10A in FIG. 4, the diameter Q1 of the opening of at least one of the first recesses 20 may be smaller than the diameter R1 of the bottom face of the first recess 20 in a cross-section of the first recess 20 in a view along the thickness direction.

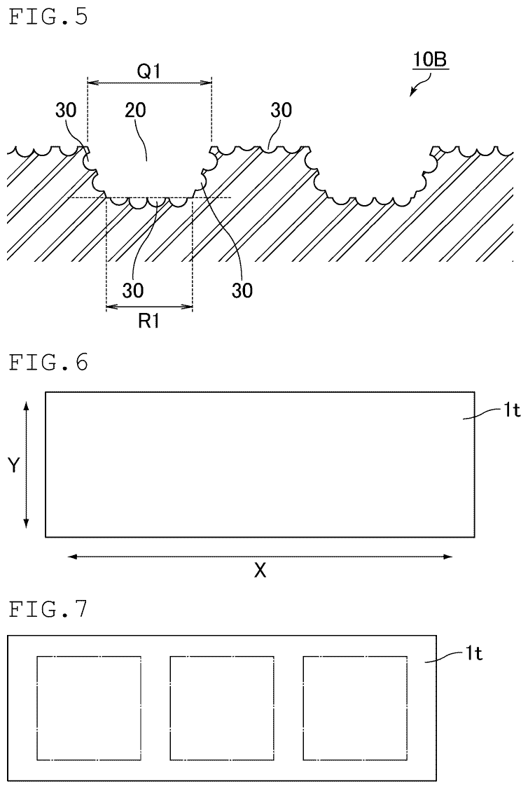

FIG. 5 is a schematic cross-sectional view of still another example of the electrolyte sheet for solid oxide fuel cells of the present description in which the cross-sectional shape of each first recess is different from that in FIG. 3 and that in FIG. 4.

As seen in an electrolyte sheet 10B in FIG. 5, the diameter Q1 of the opening of at least one of the first recesses 20 may be larger than the diameter R1 of the bottom face of the first recess 20 in a cross-section of the first recess 20 in a view along the thickness direction.

In comparison of the cross-sectional shapes of the first recesses 20 in FIG. 3, FIG. 4, and FIG. 5, the cross-sectional shape in FIG. 5 is most preferable, followed by the cross-sectional shape in FIG. 3 from the standpoint of easy entry of the slurry for an electrode (slurry for a fuel electrode or slurry for an air electrode) in the first recesses 20 when the electrolyte sheet is incorporated into a solid oxide fuel cell.

### Method of Producing Electrolyte Sheet for Solid Oxide Fuel Cells

An exemplary method of producing the electrolyte sheet for solid oxide fuel cells of the present description is described below.

An exemplary method of producing the electrolyte sheet for solid oxide fuel cells of the present description includes a step of preparing a ceramic slurry, a step of producing a ceramic green sheet by molding the ceramic slurry, a step of forming sheet through holes which penetrate the ceramic green sheet in the thickness direction and are spaced apart from each other, a step of producing an unsintered plate body by laminating a plurality of the ceramic green sheets including at least one of the ceramic green sheets with sheet through holes in the thickness direction such that the at least one of the ceramic green sheets with sheet through holes defines at least one main surface of the unsintered plate body, wherein the at least one main surface includes first recesses which are derived from the sheet through holes and are spaced apart at an interval from each other; at least one of the first recesses has an opening with a diameter of 60 μm or more; and the at least one of the first recesses has a ratio of the diameter of the opening to the diameter of the bottom face of 30% or more, a step of forming second recesses each having a smaller diameter than the first recesses between the openings of the adjacent first recesses, on the side faces of the first recesses, and on the bottom faces of the first recesses, and a step of producing a ceramic plate body by sintering the unsintered plate body with the first recesses and the second recesses.

### Preparation of Ceramic Slurry

A ceramic slurry is prepared by combining ceramic material powder, a binder, a dispersant, an organic solvent, and other additives.

Examples of the ceramic material powder include zirconia powder.

Examples of the zirconia powder include unsintered zirconia powder stabilized with an oxide of a rare-earth element such as scandium or yttrium. Specific examples include unsintered scandia-stabilized zirconia powder and unsintered yttria-stabilized zirconia powder.

The unsintered zirconia powder is preferably unsintered scandia-stabilized zirconia powder. The use of unsintered scandia-stabilized zirconia powder leads to an electrolyte sheet with high conductivity. In this case, the produced electrolyte sheet, when incorporated into a solid oxide fuel cell, can improve the power generation efficiency of the solid oxide fuel cell.

The unsintered zirconia powder is preferably unsintered cubic zirconia powder. The use of unsintered cubic zirconia powder leads to an electrolyte sheet with high conductivity. In this case, the produced electrolyte sheet, when incorporated into a solid oxide fuel cell, can improve the power generation efficiency of the solid oxide fuel cell.

Examples of the unsintered cubic zirconia powder include those stabilized with an oxide of a rare-earth element such as scandium or yttrium. Specific examples include unsintered scandia-stabilized cubic zirconia powder and unsintered yttria-stabilized cubic zirconia powder.

The unsintered cubic zirconia powder is preferably unsintered scandia-stabilized cubic zirconia powder. The use of unsintered scandia-stabilized cubic zirconia powder leads to an electrolyte sheet with significantly high conductivity. In this case, the produced electrolyte sheet, when incorporated into a solid oxide fuel cell, can significantly improve the power generation efficiency of the solid oxide fuel cell.

The zirconia powder may include sintered zirconia powder as well as the unsintered zirconia powder.

For example, the sintered zirconia powder is prepared by pulverizing a sintered zirconia.

Preferably, dry pulverization is performed to pulverize the sintered zirconia. Dry pulverization can pulverize the sintered zirconia with a strong impact force, which tends to improve the pulverization efficiency.

For example, a jet mill, a vibration mill, a planetary mill, a dry ball mill, a fine mill, or the like is used as a dry pulverizer for dry pulverization.

For example, zirconia balls or the like are used as pulverization media for a dry pulverizer.

When pulverizing the sintered zirconia, wet pulverization may be performed instead of dry pulverization, or dry pulverization and wet pulverization may be performed in combination. Performing only dry pulverization is preferred from the standpoint of pulverization efficiency.

When preparing sintered zirconia powder by pulverizing a sintered zirconia, the sintered zirconia as a raw material of the sintered zirconia powder is, for example, one obtained by sintering unsintered zirconia powder. Such a sintered zirconia may be an electrolyte sheet containing a sintered zirconia. Use of a defective electrolyte sheet with warpage, breakage, or the like or an electrolyte sheet incorporated into a solid oxide fuel cell, for example, is preferred from the standpoint of recycling. When using an electrolyte sheet in a solid oxide fuel cell, for example, the electrolyte sheet may be taken out from a used unit cell, a defective unit cell, or the like by removing a fuel electrode and an air electrode.

Examples of the sintered zirconia include those stabilized with an oxide of a rare-earth element such as scandium or yttrium. Specific examples include a sintered scandia-stabilized zirconia and a sintered yttria-stabilized zirconia.

The sintered zirconia is preferably a sintered scandia-stabilized zirconia. In other words, the sintered zirconia powder is preferably sintered scandia-stabilized zirconia powder. The use of sintered scandia-stabilized zirconia powder leads to an electrolyte sheet with high conductivity. In this case, the produced electrolyte sheet, when incorporated into a solid oxide fuel cell, can improve the power generation efficiency of the solid oxide fuel cell.

The sintered zirconia is preferably a sintered cubic zirconia. In other words, the sintered zirconia powder is preferably sintered cubic zirconia powder. The use of sintered cubic zirconia powder leads to an electrolyte sheet with high conductivity. In this case, the produced electrolyte sheet, when incorporated into a solid oxide fuel cell, can improve the power generation efficiency of the solid oxide fuel cell.

Examples of the sintered cubic zirconia include those stabilized with an oxide of a rare-earth element such as scandium or yttrium. Specific examples include a sintered scandia-stabilized cubic zirconia and a sintered yttria-stabilized cubic zirconia.

The sintered cubic zirconia is preferably a sintered scandia-stabilized cubic zirconia. In other words, the sintered zirconia powder is preferably sintered scandia-stabilized cubic zirconia powder. The use of sintered scandia-stabilized cubic zirconia powder leads to an electrolyte sheet with significantly high conductivity. In this case, the produced electrolyte sheet, when incorporated into a solid oxide fuel cell, can significantly improve the power generation efficiency of the solid oxide fuel cell.

### Production of Ceramic Green Sheet

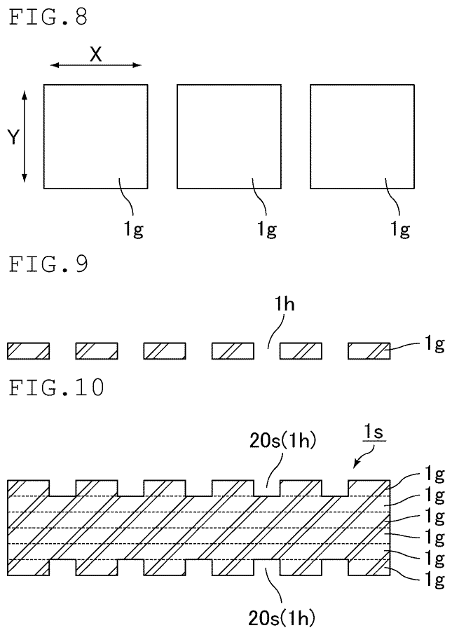

FIG. 6 is a schematic plan view of producing ceramic green sheets in an example of the method of producing the electrolyte sheet for solid oxide fuel cells of the present description. FIG. 7 is a schematic plan view showing an embodiment after the state in FIG. 6 in the production of ceramic green sheets in the example of the method of producing the electrolyte sheet for solid oxide fuel cells of the present description. FIG. 8 is a schematic plan view showing an embodiment after the state in FIG. 7 in the production of ceramic green sheets in the example of the method of producing the electrolyte sheet for solid oxide fuel cells of the present description.

First, a ceramic slurry is molded on one main surface of a carrier film to produce a ceramic green tape 1t shown in FIG. 6.

The ceramic slurry is molded preferably by tape casting, more preferably by doctor blading or calendaring. FIG. 6 shows molding of the ceramic slurry by tape casting, with the casting direction for the tape casting indicated by X and the direction perpendicular to the casting direction indicated by Y.

Then, as shown in FIG. 7, the ceramic green tape 1t is punched by a known technique into pieces having a predetermined size, and the carrier film is peeled off, whereby ceramic green sheets 1g shown in FIG. 8 are produced. The punching of the ceramic green tape 1t and the peeling off of the carrier film may be performed in any order.

### Formation of Sheet Through Hole

FIG. 9 is a schematic cross-sectional view showing formation of sheet through holes in the example of the method of producing the electrolyte sheet for solid oxide fuel cells of the present description.

As shown in FIG. 9, sheet through holes 1h which penetrate the ceramic green sheet 1g in the thickness direction and are spaced apart from each other are formed.

The sheet through holes 1h are formed in the ceramic green sheet 1g such that, regarding at least one of the sheet through holes 1h, at least one of the openings of the sheet through hole 1h has a diameter of 60 μm or more and that a ratio of the diameter of one opening to the diameter of the other opening of the sheet through hole 1h is 30% or more.

The sheet through holes 1h are formed in the ceramic green sheet 1g using, for example, a laser beam or a drill.

For example, formation of the sheet through holes 1h using a laser beam is performed by irradiating one main surface of the ceramic green sheet 1g with laser beam. By controlling the conditions of a laser beam application, the diameters of the openings of the sheet through holes 1h can be controlled, and also the cross-sections of the sheet through holes 1h in a view along the thickness direction can be appropriately controlled into a shape with a constant diameter along the thickness direction or a tapered shape with a decreasing (increasing) diameter along the thickness direction.

For example, formation of the sheet through holes 1h using a drill is performed by allowing the drill to advance from one main surface to the other main surface of the ceramic green sheet 1g. By controlling the shape of the drill and the drilling conditions, the diameters of the openings of the sheet through holes 1h can be controlled, and also the cross-sections of the sheet through holes 1h in a view along the thickness direction can be appropriately controlled into a shape with a constant diameter along the thickness direction or a tapered shape with a decreasing (increasing) diameter along the thickness direction.

### Production of Unsintered Plate Body

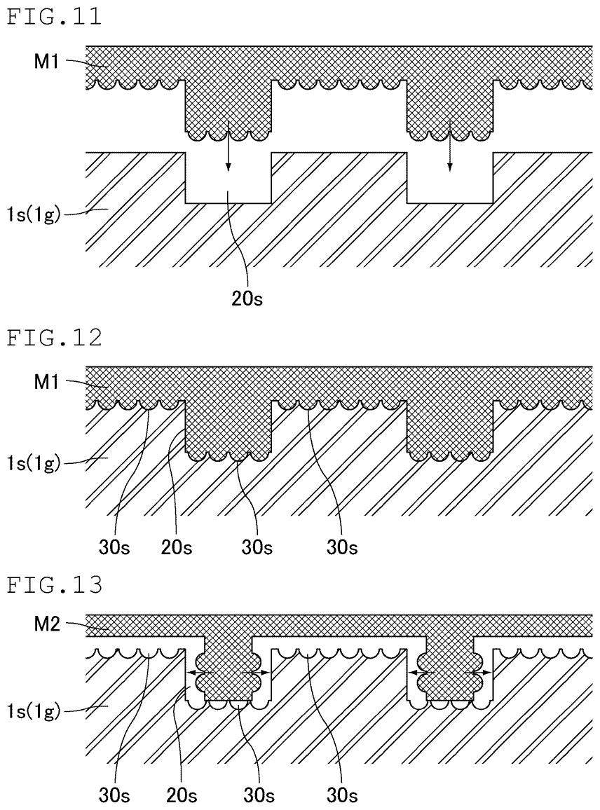

FIG. 10 is a schematic cross-sectional view showing production of an unsintered plate body in the example of the method of producing the electrolyte sheet for solid oxide fuel cells of the present description.

As shown in FIG. 10, a plurality of the ceramic green sheets 1g are laminated in the thickness direction to produce an unsintered plate body 1s. In the example in FIG. 10, the unsintered plate body 1s is produced by laminating one ceramic green sheet 1g with sheet through holes 1h, four ceramic green sheets 1g with no sheet through hole 1h, and one ceramic green sheet 1g with sheet through holes 1h in the stated order in the thickness direction.

When the unsintered plate body 1s is produced using a plurality of the ceramic green sheets 1g, the thickness of an electrolyte sheet (ceramic plate body) to be obtained can be easily controlled.

The unsintered plate body 1s is produced such that the ceramic green sheet 1g with sheet through holes 1h is laminated at a position to define at least one main surface of the unsintered plate body 1s. Specifically, the unsintered plate body 1s may be produced by laminating the ceramic green sheet 1g with sheet through holes 1h at a position to define at one main surface or the other main surface of the unsintered plate body 1s, or laminating the ceramic green sheets 1g at positions to respectively define both the main surfaces of the unsintered plate body 1s as shown in FIG. 10.

When the unsintered plate body 1s is produced by laminating the ceramic green sheet 1g with sheet through holes 1h at a position to define at least one main surface of the unsintered plate body 1s, first recesses 20s derived from the sheet through holes 1h are present with an interval therebetween on the main surface of the unsintered plated body 1s. In the example in FIG. 10, the first recesses 20s are present with an interval therebetween on both main surfaces of the unsintered plate body 1s.

The first recesses 20s become first recesses 20 in an electrolyte sheet (ceramic plate body 10p described later) to be produced. Therefore, the unsintered plate body 1s is produced by laminating the ceramic green sheet 1g with the sheet through holes 1h while controlling the direction of the ceramic green sheet 1g such that at least one of the first recesses 20s has an opening with a diameter of 60 μm or more and has a ratio of the diameter of the opening to the diameter of the bottom face of 30% or more.

The number of the ceramic green sheet 1g with no sheet through hole 1h to be laminated is not limited and may be four as in FIG. 10 or a different number.

All the thicknesses of a plurality of the ceramic green sheets 1g used to produce the unsintered plate body 1s may be the same or different from each other, or some of them may be different from each other.

In the production of the unsintered plate body 1s, the laminated plurality of the ceramic green sheets 1g may be crimped.

### Formation of Second Recesses

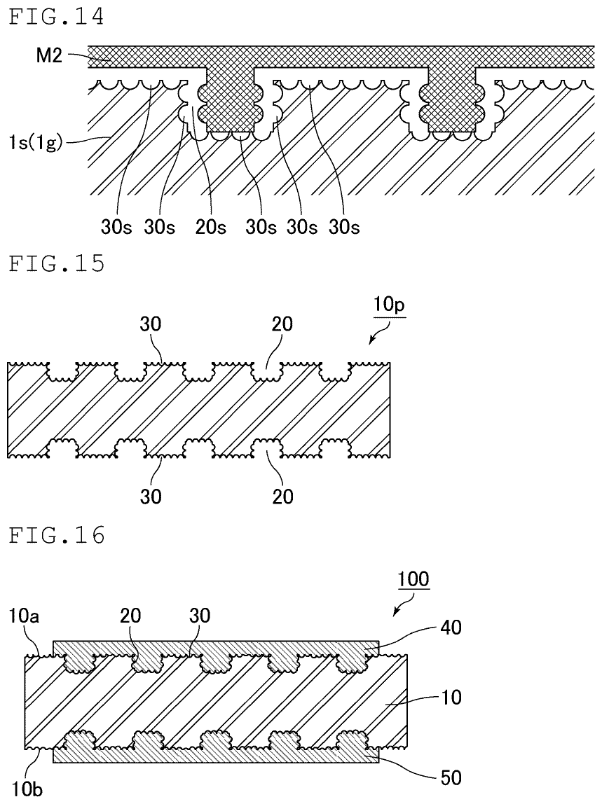

FIG. 11 is a schematic cross-sectional view showing formation of second recesses in the example of the method of producing the electrolyte sheet for solid oxide fuel cells of the present description. FIG. 12 is a schematic cross-sectional view showing an embodiment after the state in FIG. 11 in the formation of second recesses in the example of the method of producing the electrolyte sheet for solid oxide fuel cells of the present description. FIG. 13 is a schematic cross-sectional view showing an embodiment after the state in FIG. 12 in the formation of second recesses in the example of the method of producing the electrolyte sheet for solid oxide fuel cells of the present description. FIG. 14 is a schematic cross-sectional view showing an embodiment after the state in FIG. 13 in the formation of second recesses in the example of the method of producing the electrolyte sheet for solid oxide fuel cells of the present description.

FIG. 11, FIG. 12, FIG. 13, and FIG. 14 each show an enlarged view of an embodiment in which second recesses are formed on one main surface of the unsintered plate body in FIG. 10.

First, a first mold M1 including protrusions on a surface facing in the thickness direction is prepared as shown in FIG. 11.

Then, the first mold M1 is pressed against one main surface of the unsintered plate body Is in the thickness direction to form second recesses 30s each having a smaller diameter than the first recesses 20s between the openings of the adjacent first recesses 20s and on the bottom faces of the first recesses 20s as shown in FIG. 12. Preferably, the first mold M1 is pressed against the unsintered plate body 1s in the thickness direction while the unsintered plate body 1s is placed on an immobilized plate in the thickness direction.

Next, a second mold M2 including protrusions on a surface facing in a direction perpendicular to the thickness direction is prepared as shown in FIG. 13.

Then, the second mold M2 is inserted into the first recesses 20s and then pressed against the side faces of the first recesses 20s in the direction perpendicular to the thickness direction to form second recesses 30s each having a smaller diameter than the first recesses 20s on the side faces of the first recesses 20s as shown in FIG. 14. Preferably, the second mold M2 is pressed against the unsintered plate body 1s in the direction perpendicular to the thickness direction while the unsintered plate body 1s is sandwiched between two immobilized plates in the direction perpendicular to the thickness direction.

Accordingly, the second recesses 30s each having a smaller diameter than the first recesses 20s are formed on one main surface of the unsintered plate body 1s between the openings of the adjacent first recesses 20s, on the side faces of the first recesses 20s, and on the bottom faces of the first recesses 20s.

Likewise, the second recesses 30s each having a smaller diameter than the first recesses 20s may be formed on the other main surface of the unsintered plate body 1s between the openings of the adjacent first recesses 20s, on the side faces of the first recesses 20s, and on the bottom faces of the first recesses 20s.

The second recesses 30s become second recesses 30 in an electrolyte sheet (ceramic plate body 10p described later) to be produced.

In the formation of the second recesses 30s on the unsintered plate body 1s, the interval between the second recesses 30s and the diameter, depth, number, position, shape, and the like of the second recesses 30s may be controlled by controlling the specifications of the first mold M1 and the second mold M2.

In the above description, the second recesses 30s are formed first between the openings of the adjacent first recesses 20s and on the bottom faces of the first recesses 20s (see, FIG. 11 and FIG. 12) and then on the side faces of the first recesses 20s (see, FIG. 13 and FIG. 14). The order may be opposite. Specifically, the second recesses 30s may be formed first on the side faces of the first recesses 20s and then between the openings of the adjacent first recesses 20s and on the bottom faces of the first recesses 20s.

An exemplary method of forming the second recesses 30s on the unsintered plate body 1s using a mold is described above. Methods other than the method using a mold may be employed.

### Formation of Through Holes Penetrating Unsintered Plate Body

Though not shown, through holes penetrating the unsintered plate body 1s in the thickness direction may be formed in the unsintered plate body 1s in a region where none of the first recesses 20s and the second recesses 30s present between the openings of the first recesses 20s is lost by the through holes.

Preferably, the through holes penetrating the unsintered plate body 1s are formed in the unsintered plate body 1s using a drill. In this case, for example, the through holes penetrating the unsintered plate body 1s in the thickness direction are formed by advancing the drill from one main surface to the other main surface of the unsintered plate body 1s. The shape of the drill and the drilling conditions are not limited.

In the formation of the through holes penetrating the unsintered plate body 1s in the unsintered plate body 1s, the number of the through holes penetrating the unsintered plate body 1s may be only one or two or more.

The formation of the second recesses and the formation of the through holes penetrating the unsintered plate body may be performed in any order. Specifically, the through holes penetrating the unsintered plate body may be formed after the formation of the second recesses or the second recesses may be formed after the formation of the through holes penetrating the unsintered plate body.

The unsintered plate body 1s may have no through hole penetrating the unsintered plate body 1s. In this case, the above-described step is omitted.

### Production of Ceramic Plate Body

FIG. 15 is a schematic cross-sectional view showing production of a ceramic plate body in the example of the method of producing the electrolyte sheet for solid oxide fuel cells of the present description.

A ceramic plate body 10p shown in FIG. 15 is produced by firing the unsintered plate body 1s with the first recesses 20s and the second recesses 30s to sinter the unsintered plate body 1s.

In the example shown in FIG. 15, the first recesses 20 derived from the first recesses 20s are formed on both main surfaces of the ceramic plate body 10p, where the first recesses 20 are spaced apart at an interval from each other. Further, in the ceramic plate body 10p, at least one of the first recesses 20 has an opening with a diameter of 60 μm or more, and has a ratio of the diameter of the opening to the diameter of the bottom face of 30% or more.

In the example shown in FIG. 15, the second recesses 30 which are derived from the second recesses 30s and each have a smaller diameter than the first recesses 20 are formed on both main surfaces of the ceramic plate body 10p between the openings of the adjacent first recesses 20, on the side faces of the first recesses 20, and on the bottom faces of the first recesses 20.

In the firing of the unsintered plate body 1s, preferably, degreasing and sintering are performed.

When the through holes penetrating the unsintered plate body 1s are formed in the unsintered plate body 1s, through holes penetrating the ceramic plate body 10p in the thickness direction are formed.

Accordingly, an electrolyte sheet including the ceramic plate body 10p is produced.

### Unit Cell for Solid Oxide Fuel Cells

The unit cell for solid oxide fuel cells of the present description includes a fuel electrode, an air electrode, and the electrolyte sheet for solid oxide fuel cells of the present description between the fuel electrode and the air electrode.

An example of the unit cell for solid oxide fuel cells of the present description is described below.

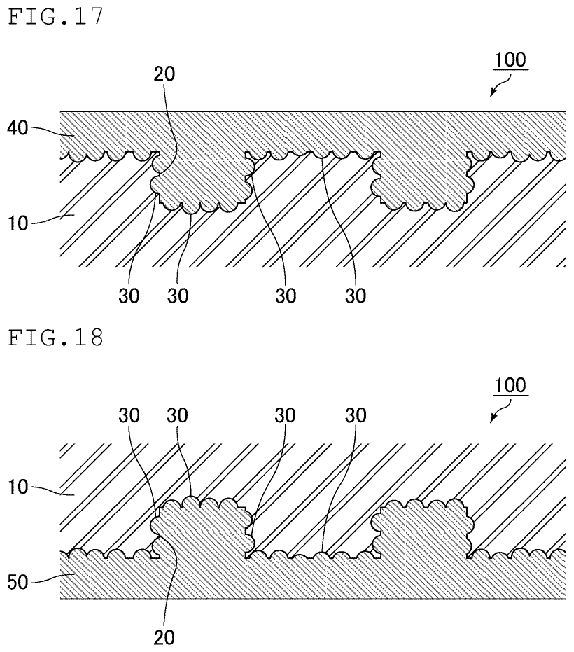

FIG. 16 is a schematic cross-sectional view of an example of the unit cell for solid oxide fuel cells of the present description. FIG. 17 is an enlarged schematic cross-sectional view of an interface between an electrolyte sheet and a fuel electrode in the unit cell in FIG. 16. FIG. 18 is an enlarged schematic cross-sectional view of an interface between an electrolyte sheet and an air electrode in the unit cell in FIG. 16.

A unit cell 100 for solid oxide fuel cells in FIG. 16 includes a fuel electrode 40, an air electrode 50, and an electrolyte sheet 10. The electrolyte sheet 10 is disposed between the fuel electrode 40 and the air electrode 50.

The fuel electrode 40 may be a known fuel electrode for solid oxide fuel cells.

The air electrode 50 may be a known air electrode for solid oxide fuel cells.

As described above, at least one main surface (both main surfaces in the example in FIG. 16) of the electrolyte sheet 10 includes the first recesses 20 and the second recesses 30. Also, at least one of the first recesses 20 has an opening with a diameter of 60 μm or more, and has a ratio of the diameter of the opening to the diameter of the bottom face of 30% or more.

When the unit cell 100 is produced using the electrolyte sheet 10 that satisfies the above-described specification as described below, a slurry for the fuel electrode 40 and a slurry for the air electrode 50 significantly easily enter the first recesses 20 and also easily enter the second recesses 30 on the side faces and the bottom faces of the first recesses 20. In the resulting unit cell 100, the electrolyte sheet 10 tends to have a significantly large contact area with the fuel electrode 40 as shown in FIG. 17, while the electrolyte sheet 10 tends to have a significantly large contact area with the air electrode 50 as shown in FIG. 18, thereby significantly facilitating the improvement of the power generation efficiency of the solid oxide fuel cell including the unit cell 100.

In order to use the unit cell 100 in a solid oxide fuel cell, a fuel gas flow path to supply fuel gas to the fuel electrode 40 and an air flow path to supply air to the air electrode 50 are necessary.

For example, the unit cell 100 may be provided with the fuel gas flow path by laminating a first separator on the main surface of the fuel electrode 40 on the side opposite to the electrolyte sheet 10, the first separator including the fuel gas flow path, which is for supplying fuel gas, in the main surface of the first separator on the fuel electrode 40 side.

For example, the unit cell 100 may be provided with the air flow path by laminating a second separator on the main surface of the air electrode 50 on the side opposite to the electrolyte sheet 10, the second separator including the air flow path, which is for supplying air, in the main surface of the second separator on the air electrode 50 side.

Examples of the material of the first separator and the material of the second separator include insulating materials such as ceramic materials and conductive materials such as metal materials.

The material of the first separator and the material of the second separator may be the same or different from each other.

When the materials of the first separator and the second separator are insulating materials, examples of the insulating materials of the first separator and the second separator include a sintered partially stabilized zirconia.

When the material of the first separator is an insulating material, preferably, the first separator includes at least one through conductor that penetrates the first separator in the thickness direction to be connected to the fuel electrode 40 and exposed to the main surface of the first separator on the side opposite to the fuel electrode 40. In this case, the fuel electrode 40 can be conducted out of the first separator via the through conductor.

When the material of the second separator is an insulating material, preferably, the second separator includes at least one through conductor that penetrates the second separator in the thickness direction to be connected to the air electrode 50 and exposed to the main surface of the second separator on the side opposite to the air electrode 50. In this case, the air electrode 50 can be conducted out of the second separator via the through conductor.

Preferably, the materials of the through conductors in the first separator and the second separator are platinum or an alloy of silver and palladium.

The material of the through conductor in the first separator and the material of the through conductor in the second separator may be the same or different from each other.

### Method of Producing Unit Cell for Solid Oxide Fuel Cells

An exemplary method of producing the unit cell for solid oxide fuel cells of the present description is described below.

First, a powder of a material of a fuel electrode is appropriately mixed with a binder, a dispersant, a solvent, and other additives to prepare a slurry for a fuel electrode.

Also, a powder of a material of an air electrode is appropriately mixed with a binder, a dispersant, a solvent, and other additives to prepare a slurry for an air electrode.

The material of the fuel electrode may be a known material of a fuel electrode for solid oxide fuel cells.

The material of the air electrode may be a known material of an air electrode for solid oxide fuel cells.

The binder, dispersant, solvent, and other additives in the slurry for a fuel electrode and the slurry for an air electrode may be those known in methods of forming a fuel electrode and an air electrode for solid oxide fuel cells.

Next, the slurry for a fuel electrode is applied to a predetermined thickness to one main surface of the electrolyte sheet, and the slurry for an air electrode is applied to a predetermined thickness to the other main surface of the electrolyte sheet. Since the electrolyte sheet satisfies the above-described specification, one or both of the slurry for a fuel electrode and the slurry for an air electrode significantly easily enter (s) the first recesses and also easily enters the second recesses on the side faces and bottom faces of the first recesses. In the resulting unit cell, the electrolyte sheet tends to have a large contact area with the electrode (fuel electrode or air electrode).

Thereafter, these coating films are dried into a green layer for a fuel electrode and a green layer for an air electrode.

The green layer for a fuel electrode and the green layer for an air electrode are then fired to form a fuel electrode and an air electrode. The firing conditions such as firing temperature may be appropriately determined depending on the materials and the like of the fuel electrode and the air electrode.

Accordingly, a unit cell is produced.

### EXAMPLES

Examples that more specifically disclose the electrolyte sheet for solid oxide fuel cells of the present description are described below. The present description is not limited to the examples.

### Example 1

An electrolyte sheet of Example 1 was produced by the following method.

### Preparation of Ceramic Slurry

First, unsintered zirconia powder, sintered zirconia powder, a binder, a dispersant, and an organic solvent were compounded at a predetermined ratio.

The unsintered zirconia powder was unsintered scandia-stabilized zirconia powder.

The sintered zirconia powder was sintered scandia-stabilized zirconia powder prepared by pulverizing a sintered scandia-stabilized zirconia.

The organic solvent was a solvent mixture of toluene and ethanol (weight ratio 7:3).

Then, the compounded product was stirred with media made of partially stabilized zirconia at 1000 rpm for three hours to prepare a ceramic slurry.

### Production of Ceramic Green Sheet

First, the ceramic slurry was tape-casted by a known technique onto one main surface of a carrier film made of polyethylene terephthalate. Thus, a ceramic green tape was produced.

Then, the ceramic green tape was punched by a known technique into pieces having a predetermined size, and the carrier film was peeled off. Thus, ceramic green sheets were produced.

### Formation of Sheet Through Hole

One main surface of the ceramic green sheet was irradiated with a laser beam to form sheet through holes penetrating the ceramic green sheet in the thickness direction.

### Production of Unsintered Plate Body

An unsintered plate body was produced by laminating one of the ceramic green sheets with sheet through holes, a predetermined number of the ceramic green sheets with no sheet through hole, and one of the ceramic green sheets with sheet through holes in the stated order in the thickness direction. First recesses derived from the sheet through holes were present with an interval therebetween on both main surfaces of the unsintered plate body.

### Formation of Second Recesses

First, a first mold including protrusions on a surface facing in the thickness direction was prepared.

Then, the first mold was pressed against one main surface of the unsintered plate body in the thickness direction to form second recesses each having a smaller diameter than the first recesses between the openings of the adjacent first recesses and on the bottom faces of the first recesses. Here, the first mold was pressed against the unsintered plate body in the thickness direction while the unsintered plate body was placed on an immobilized plate in the thickness direction.

Next, a second mold including protrusions on a surface facing in a direction perpendicular to the thickness direction was prepared.

Then, the second mold was inserted into the first recesses and then pressed against the side faces of the first recesses in the direction perpendicular to the thickness direction to form second recesses each having a smaller diameter than the first recesses on the side faces of the first recesses. Here, the second mold was pressed against the unsintered plate body in the direction perpendicular to the thickness direction while the unsintered plate body was sandwiched between two immobilized plates in the direction perpendicular to the thickness direction.

Accordingly, the second recesses each having a smaller diameter than the first recesses were formed on one main surface of the unsintered plate body between the openings of the adjacent first recesses, on the side faces of the first recesses, and on the bottom faces of the first recesses.

Likewise, the second recesses each having a smaller diameter than the first recesses were formed on the other main surface of the unsintered plate body between the openings of the adjacent first recesses, on the side faces of the first recesses, and on the bottom faces of the first recesses.

### Formation of Through Holes Penetrating Unsintered Plate Body

Through holes penetrating the unsintered plate body in the thickness direction were formed using a drill in the unsintered plate body in a region where none of the first recesses and the second recesses present between the openings of the first recesses was lost by the through holes.

Regarding the drilling conditions, the feed rate was set to 0.04 mm/rotation and the spindle speed was set to 2000 rpm.

### Production of Ceramic Plate Body

The unsintered plate body with the first recesses and the second recesses was kept in a firing furnace at 400° C. for a predetermined time for degreasing. The degreased unsintered plate body was kept in a firing furnace at 1400° C. for five hours for sintering.

The unsintered plate body was fired as described above to sinter the unsintered plate body into a ceramic plate body.

Thus, an electrolyte sheet (ceramic plate body) of Example 1 was produced.

Both main surfaces of the electrolyte sheet of Example 1 each included first recesses which were spaced apart at an interval and also included second recesses each having a smaller diameter than the first recesses between the openings of the adjacent first recesses, on the side faces of the first recesses, and on the bottom faces of the first recesses.

The specification of the electrolyte sheet of Example 1 was as follows (also shown in Table 1).

Diameter of the opening of each first recess: 60 μm

Ratio of the diameter of the opening of each first recess to the diameter of the bottom face of the first recess: 70%

Ratio of the depth of the first recess to the thickness of the electrolyte sheet: 10%

Interval between adjacent first recesses: 70 μm

### Examples 2 to 6 and Comparative Examples 1 to 4

Electrolyte sheets of Examples 2 to 6 and Comparative Examples 1 to 4 were produced as in the production of the electrolyte sheet of Example 1, except that the specifications of the electrolyte sheets were as shown in Table 1.

In the production of the electrolyte sheet of Comparative Example 1, the formation of sheet through holes was not performed so that no first recess was formed on the electrolyte sheet.

In the production of the electrolyte sheet of Comparative Example 2, the formation of second recesses was not performed so that no second recess was formed on the electrolyte sheet.

In Table 1, the “diameter of the opening of each first recess” is abbreviated as “diameter of opening”; the “ratio of the diameter of the opening of each first recess to the diameter of the bottom face of the first recess” is abbreviated as “opening diameter ratio”; the “ratio of the depth of the first recess to the thickness of the electrolyte sheet” is abbreviated as “depth ratio”; and the “interval between adjacent first recesses” is abbreviated as “interval”.

### Evaluation

The electrolyte sheets of Examples 1 to 6 and Comparative Examples 1 to 4 were subjected to the following evaluations. Table 1 shows the evaluation results.

### Power Generation Efficiency

First, a unit cell sample for measuring power generation efficiency described below was prepared from the electrolyte sheet.

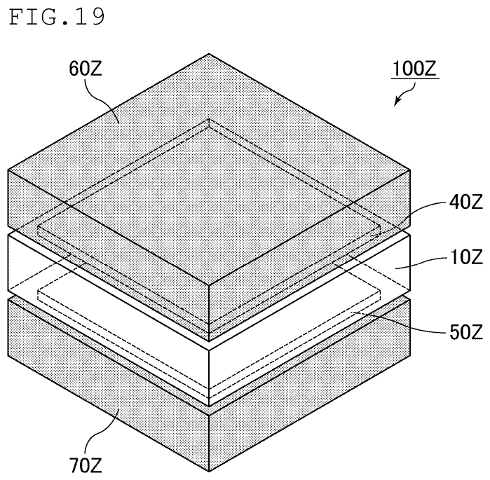

FIG. 19 is a schematic perspective view of a unit cell sample for measuring power generation efficiency.

As shown in FIG. 19, a unit cell sample 100Z included an electrolyte sheet 10Z, a fuel electrode 40Z on one main surface of the electrolyte sheet 10Z, an air electrode 50Z on the other main surface of the electrolyte sheet 10Z, a first separator 60Z on a main surface of the fuel electrode 40Z on the side opposite to the electrolyte sheet 10Z, and a second separator 70Z on a main surface of the air electrode 50Z on the side opposite to the electrolyte sheet 10Z.

FIG. 19 does not show the specification of the surfaces including the first recesses, the second recesses, and the like of the electrolyte sheet 10Z.

The first separator 60Z used was a sintered partially stabilized zirconia. Though not shown, the first separator 60Z included a fuel gas flow path, which is for supplying fuel gas, in the main surface of the first separator 60Z on the fuel electrode 40Z side. Though not shown, the first separator 60Z included through conductors (preferable material thereof is platinum or an alloy of silver and palladium) which were formed by filling formed through holes with a conductive paste and which were connected to the fuel electrode 40Z and were exposed to the main surface of the first separator 60Z on the side opposite to the fuel electrode 40Z.

The second separator 70Z used was a sintered partially stabilized zirconia. Though not shown, the second separator 70Z included an air flow path, which is for supplying air, in the main surface of the second separator 70Z on the air electrode 50Z side. Though not shown, the second separator 70Z included through conductors (preferable material thereof is platinum or an alloy of silver and palladium) which were formed by filling formed through holes with a conductive paste and which were connected to the air electrode 50Z and were exposed to the main surface of the second separator 70Z on the side opposite to the air electrode 50Z.

Then, the power generation efficiency of the unit cell sample 100Z was determined using the formula: Power generation efficiency η=A×V×Uf.

The A refers to a constant defined by the formula:

$$A = n \times F / Δ H .$$

The n refers to the number of electrons relating the reaction. This evaluation used n=8 on the assumption that the fuel used was city gas which causes an eight-electron reaction in terms of pure methane (CH₄).

The F refers to the Faraday constant. This evaluation used F=9.648×10⁴ C/mol.

The ΔH refers to the heat of combustion. This evaluation used ΔH=890.36 KJ/mol (for greater heating value, HHV) or ΔH=802.29 KJ/mol (for less heating value, LHV).

Accordingly, A≈0.867 (for HHV) and A≈0.962 (for LHV) were calculated. This evaluation used A=0.962 (for LHV).

The V refers to the voltage inside the unit cell sample 100Z measured as follows. First, the unit cell sample 100Z was placed on a measurement apparatus equipped with a metal terminal jig capable of measuring current and voltage, a fuel gas and air supply system, and a temperature increase system. Next, through conductors exposed to the main surface of the first separator 60Z and through conductors exposed to the main surface of the second separator 70Z of the unit cell sample 100Z were brought into contact with the metal terminal jig. While keeping this state, the temperature inside the measurement apparatus was increased to 750° C. Thereafter, fuel gas in an amount calculated to give a fuel consumption rate indicated by Uf of 72.5% was supplied to the fuel electrode 40Z side, while air in an amount calculated to give an air consumption rate of 30% was supplied to the air electrode 50Z side. Then, the voltage V inside the unit cell sample 100Z was measured under a current density of 0.4 A/cm² by the 4-terminal method using a commercial potentiostat/galvanostat.

As described above, the Uf refers to a fuel consumption rate. This evaluation used an expected value of the Uf of 72.5%.

### Strength

First, the electrolyte sheet was placed at the center of a precision universal tester “AGS-X” available from Shimadzu Corporation, with lower jigs being spaced apart by 32.5 mm from each other and upper jigs being spaced apart by 65 mm from each other. The upper jigs were lowered at a rate of 5 mm/min, whereby a four-point bending test of the electrolyte sheet was performed to measure the strength of the electrolyte sheet. The judging criteria were as follows, with the strength reduction rate of the electrolyte sheet of Comparative Example 1 taken as an index.

Good: The strength reduction rate was less than 20%.

Poor: The strength reduction rate was 20% or more.

TABLE 1

| | | | | | | | | Com- | Com- | Com- | Com- |
|---|---|---|---|---|---|---|---|---|---|---|---|
| | | Example | Example | Example | Example | Example | Example | parative | parative | parative | parative |
| | | 1 | 2 | 3 | 4 | 5 | 6 | Example 1 | Example 2 | Example 3 | Example 4 |
| First | Present/Not | Present | Present | Present | Present | Present | Present | Not | Present | Present | Present |
| recess | present | | | | | | | present | | | |
| | Diameter of | 60 | 60 | 100 | 100 | 150 | 200 | — | 60 | 59 | 60 |
| | opening (μm) | | | | | | | | | | |
| | Opening diameter | 70 | 30 | 100 | 80 | 130 | 80 | — | 70 | 90 | 29 |
| | ratio (%) | | | | | | | | | | |
| | Depth ratio (%) | 10 | 20 | 20 | 21 | 16 | 16 | — | 10 | 10 | 20 |
| | Interval (μm) | 70 | 70 | 50 | 50 | 100 | 100 | — | 70 | 70 | 70 |
| Second | Present/Not | Present | Present | Present | Present | Present | Present | Present | Not | Present | Present |
| recess | present | | | | | | | | present | | |

| | | | | | | | | | | |
|---|---|---|---|---|---|---|---|---|---|---|
| Power generation | 53.5 | 53.8 | 53.8 | 55.0 | 53.5 | 53.5 | 53.0 | 53.0 | 52.8 | 52.2 |
| efficiency (%) | | | | | | | | | | |
| Strength | Good | Good | Good | Poor | Good | Good | — | Good | Good | Good |

As shown in Table 1, the electrolyte sheets of Examples 1 to 6 in which the first recesses each had an opening with a diameter of 60 μm or more and a ratio of the opening of each first recess to the diameter of the bottom face of the first recess was 30% or more in unit cells achieved high power generation efficiency as compared to the electrolyte sheets of Comparative Examples 1 to 4 in unit cells. In order to achieve high power generation efficiency in a unit cell, one or both of the voltage (V) and the fuel consumption rate (Uf) need (s) to be high, as understood from the above formula (Power generation efficiency η=A×V×Uf). In this evaluation using a constant (72.5%) as the fuel consumption rate (Uf) as described above, high voltage (V) was achieved by the use of any one of the electrolyte sheets of Examples 1 to 6.

Further, the electrolyte sheets of Examples 1, 2, 3, 5, and 6 each having a ratio of the depth of each first recess to the thickness of the electrolyte sheet of 20% or less had high strength.

The electrolyte sheet of Comparative Example 1 having no first recess did not have a sufficiently large surface area and could not achieve high power generation efficiency.

The electrolyte sheet of Comparative Example 2 having no second recess did not have a sufficiently large surface area and could not achieve high power generation efficiency.

In the electrolyte sheet of Comparative Example 3 in which the first recesses each had an opening with a diameter of smaller than 60 μm, the slurry for a fuel electrode and the slurry for an air electrode did not easily enter the first recesses. Consequently, the electrolyte sheet did not have a large contact area with the fuel electrode and also did not have a large contact area with the air electrode. Thus, the electrolyte sheet of Comparative Example 3 could not achieve high power generation efficiency.

In the electrolyte sheet of Comparative Example 4 in which a ratio of the diameter of the opening of each first recess to the diameter of the bottom face of the first recess was less than 30%, the slurry for a fuel electrode and the slurry for an air electrode did not easily enter the first recesses. Consequently, the electrolyte sheet did not have a large contact area with the fuel electrode and also did not have a large contact area with the air electrode. Thus, the electrolyte sheet of Comparative Example 4 could not achieve high power generation efficiency.

### REFERENCE SIGNS LIST

1g ceramic green sheet
1h sheet through hole
1s unsintered plate body
1t ceramic green tape
10, 10A, 10B, 10Z electrolyte sheet for solid oxide fuel cells (electrolyte sheet)
10a first main surface of electrolyte sheet
10b second main surface of electrolyte sheet
10p ceramic plate body
20, 20s first recess
30, 30s second recess
40, 40Z fuel electrode
50, 50Z air electrode
60Z first separator
70Z second separator
100 unit cell for solid oxide fuel cells (unit cell)
100Z unit cell sample
M1 first mold
M2 second mold
P1 interval (pitch) between first recesses
P2 interval (pitch) between second recesses
Q1 diameter of opening of first recess
Q2 diameter of opening of second recess
R1 diameter of bottom face of first recess
S1 depth of first recess
S2 depth of second recess
T thickness of electrolyte sheet
X casting direction
Y direction perpendicular to casting direction

1. An electrolyte sheet for solid oxide fuel cells, wherein
at least one main surface of the electrolyte sheet includes first recesses and second recesses, the second recesses each having a smaller diameter than the first recesses,
the first recesses are spaced apart at an interval from each other,
the second recesses are present between openings of adjacent first recesses among the first recesses, on side faces of the first recesses, and on bottom faces of the first recesses,
at least one of the first recesses has an opening with a diameter of 60 μm or more, and
the at least one of the first recesses has a ratio of the diameter of the opening to a diameter of the bottom face of 30% or more.

2. The electrolyte sheet according to claim 1, wherein a ratio of a depth of the at least one of the first recesses to a thickness of the electrolyte sheet is 20% or less.

3. The electrolyte sheet according to claim 1, wherein the ratio of the diameter of the opening of the at least one of the first recesses to the diameter of the bottom face of the at least one of the first recesses is 30% to 100%.

4. The electrolyte sheet according to claim 1, wherein the electrolyte sheet contains sintered zirconia.

5. The electrolyte sheet according to claim 1, wherein the at least one main surface includes a first main surface and a second main surface, and the first recesses and the second recesses are present on both the first main surface and the second main surface of the electrolyte sheet.

6. The electrolyte sheet according to claim 5, wherein the first recesses on the first main surface and the first recesses on the second main surface overlap each other in a thickness direction of the electrolyte sheet.

7. The electrolyte sheet according to claim 1, wherein the interval between the adjacent first recesses is 50 μm to 200 μm.

8. The electrolyte sheet according to claim 1, wherein the diameter of the opening of the at least one of the first recesses is 60 μm to 200 μm.

9. The electrolyte sheet according to claim 1, wherein the ratio of the diameter of the opening of the at least one of the first recesses to the diameter of the bottom face of the at least one of the first recesses is 30% to 150%.

10. The electrolyte sheet according to claim 1, wherein a ratio of a depth of the at least one of the first recesses to a thickness of the electrolyte sheet is 10% to 20%.

11. The electrolyte sheet according to claim 1, wherein a ratio of a depth of each of the first recesses to a thickness of the electrolyte sheet is 20% or less.

12. The electrolyte sheet according to claim 1, wherein the first recesses have a same three-dimensional shape.

13. The electrolyte sheet according to claim 1, wherein an interval between adjacent second recesses among the second recesses is 1 μm to 5 μm.

14. The electrolyte sheet according to claim 1, wherein a diameter of an opening of at least one of the second recesses is 1 μm to 5 μm.

15. The electrolyte sheet according to claim 1, wherein a ratio of a diameter of an opening of at least one of the second recesses to the diameter of the opening of the at least one of the first recesses is 0.5% to 8.5%.

16. A unit cell for solid oxide fuel cells, the unit cell comprising:
a fuel electrode;
an air electrode; and
the electrolyte sheet according to claim 1 between the fuel electrode and the air electrode.
